(19) United States
(12) Patent Application Publication
(10) Pub. No.: US 2025/0382187 A1
(43) Pub. Date: Dec. 18, 2025

(54) Process for Producing a Precipitated Silica Containing Manganese from Plant Ashes, Precipitated Silica and Its Use in Tire Applications

(71) Applicant: Rhodia Operations, Lyon (FR)

(72) Inventors: François Payan, Aubervilliers (FR); Youssef Chkounda, Aubervilliers (FR); Cédric Feral-Martin, Aubervilliers (FR)

(21) Appl. No.: 19/314,066

(22) Filed: Aug. 29, 2025

Related U.S. Application Data
(63) Continuation of application No. PCT/EP2024/058561, filed on Mar. 28, 2024.

(30) Foreign Application Priority Data
Mar. 29, 2023 (EP) 23305439.4
Mar. 29, 2023 (EP) 23305440.2
Jul. 13, 2023 (EP) 23185224.5
Jul. 13, 2023 (EP) 23185252.6

(51) Int. Cl. C01B 33/193; B60C 1/00; C08K 3/36

(52) U.S. Cl. CPC C01B 33/193; C08K 3/36; B60C 1/00; C01P 2006/80

(57) ABSTRACT

Provided herein is a process for producing a precipitated silica from a plant ash, wherein said precipitated silica contains SiO₂ in particulate form and manganese. Also provided herein is a precipitated silica obtainable by the above process and containing SiO₂ in particulate form and manganese and its use for the manufacture of a filled elastomeric composition, a tire part and/or a tire.

### CROSS REFERENCE TO RELATED APPLICATIONS

This application is a bypass continuation of International Patent Application No. PCT/EP2024/058561 filed Mar. 28, 2024, which claims priority to European Applications No. 23305439.4 and No. 23305440.2, both filed Mar. 29, 2023, and European Applications No. 23185252.6 and No. 23185224.5, both filed Jul. 13, 2023, the disclosures of which are hereby incorporated by reference in their entireties.

### BACKGROUND OF THE INVENTION

### Field of the Invention

The invention relates to a process for producing a precipitated silica from a plant ash. The process comprises the alkaline digestion of said plant ash to obtain a silicate solution, which is in turn reacted with an acidifying agent to achieve precipitation of SiO₂. The process is characterized in that the plant ash is directly subjected to the alkaline digestion, preferably without being subjected to any pre-treatment such as washing and/or incinerating. The invention further concerns a precipitated silica, preferably obtainable or obtained by said process. The invention further concerns the use of a precipitated silica, preferably obtainable or obtained by said process, for the manufacture of a filled elastomeric composition, a tire part and/or a tire.

### Description of Related Art

Silicon dioxide (SiO₂), also known as silica, is a silicon compound that is commonly found in nature. Naturally occurring silica exists both in amorphous and crystalline forms such as cristobalite, tridymite and quartz, the latter being the major constituent of sand.

Quartz sand is frequently employed for the production of silicates, in particular sodium silicates, which can be obtained, for example, by hydrothermal treatment of quartz sand with strong bases such as sodium hydroxide, or by fusion of quartz sand with sodium carbonate at high temperatures of around 1400-1500° C.

Sodium silicates can be used as such or can be employed as raw materials for the preparation of various inorganic materials, notably silica gel and precipitated silica. Precipitated silica is a form of synthetic silica in amorphous form.

Both silicates and precipitated silica are highly versatile materials with a variety of applications in the most diverse technological fields, from constructions to detergents, tire, adhesives, food and pharmaceutical industries, and their global demand is constantly increasing.

However, the above-mentioned processes for producing precipitated silica have the major disadvantages that sand, used as raw material, is not a renewable resource over human timescales as its replenishment happen through rocks erosion or weathering processes over geological time.

Moreover, the aforementioned conventional process for manufacturing silica by sand fusion requires a high consumption of energy because this process requires that the reactants be heated to elevated temperatures.

It appears thus clear that there remains a need to find a process for producing precipitated silica which is not only more environmentally sustainable but also cost-effective.

A possible renewable source can be envisaged in the ashes derived from the combustion of plants or plant parts and, in particular, plant ashes derived from the combustion of silica-rich plants. In this regard, one particularly rich biogenic source of silica, are the ashes deriving from rice husk.

Rice husk is an agricultural residue of the rice milling industry and is abundant in rice producing countries. Upon burning, about 20% of the weight of the rice husk is converted into ash comprising up to 97 wt.-% of silica.

In view of the high amount of silica contained in these ashes and their intrinsically renewable nature, many efforts have been made to try to extract silica from them as this could represent an economically feasible option for obtaining precipitated silica, which could also address the issue of appropriate disposal of rice husk (which, as mentioned before, is a waste material of the milling industry).

However, one of the criticalities of employing plant ashes and, in particular, rice husk ashes (RHA) as starting material, relates to the complex nature and variable composition of said ashes, which, in addition to SiO₂, generally comprise other elements such as carbon, K, Mn, P, S, etc. Since, for a multitude of applications, a high purity precipitated silica is often desired, many efforts have been made to try to purify said ashes with the aim of lowering the content of the above-mentioned elements prior to the alkaline digestion of the ashes.

WO2019/168690 describes a process for the preparation of silicate from RHA. In this process, clean water is used in order to remove the impurities contained in the rice husk ashes down to a level <250 ppm (of S and Cl) prior to the alkaline digestion of said ashes, so as to obtain a high purity silicate.

A main disadvantage of this kind of process is that washing steps use very large quantities of water, which could be usable for other needs. This fact has a negative impact on not only the overall costs and complexity of the process but also on the environment as it contributes to the resource scarcity of the planet.

IN2020/21056035 discloses a process for preparing a precipitated silica from RHA, wherein RHA are incinerated (re-burnt) at a temperature of 900° C. to 1025° C. prior to the alkaline digestion of the ashes to remove carbon, moisture and any other volatile material to achieve a precipitated silica with high purity. Similarly, Todkar et al. in International Journal of Engineering Research and Development, Volume 12, Issue 3 (March 2016), pp. 69-74 disclose a process for preparing a precipitated silica from RHA wherein a white ash is obtained after complete combustion of rice husk (emphasis added on “white” and “complete”) under controlled conditions: rice husk is burnt off in a furnace at a temperature range of 800-850° C., then heating is continued till white ash is formed.

In addition, in this case, such a pre-treatment of the ashes is energy consuming and disadvantageous for the economy and ecological impact and of the process.

Therefore, there was still the need to develop a novel process for producing a precipitated silica which is easy, environmentally friendly and cost-efficient.

### SUMMARY OF THE INVENTION

The present invention relates to a process for producing a precipitated silica from a plant ash, said process comprising the steps of:
(I) reacting a plant ash containing SiO₂ and manganese in a weight amount, expressed as elemental manganese, of at least 10 ppm, based on the weight of SiO₂ contained in the plant ash, with an alkali metal base, preferably an alkali metal hydroxide, at a temperature of at least 100° C. in an aqueous reaction medium, so as to obtain an aqueous silicate solution comprising
   (i) SiO₂ in the form of silicate anions and (ii) manganese in a weight amount, expressed as elemental manganese, of at least 10 ppm, based on the weight of SiO₂ contained in the silicate solution, and
(II) reacting the aqueous silicate solution with an acidifying agent at a temperature of at least 40° C. in an aqueous reaction medium having a pH that exceeds 7.0 during at least part of the duration of the reaction, so as to achieve precipitation of SiO₂ and produce an aqueous slurry comprising SiO₂ in particulate form and manganese in a weight amount, expressed as elemental manganese, of at least 10 ppm, based on the weight of SiO₂ contained in the aqueous slurry.

The process according to the invention optionally further comprises a step (A), prior to step (I), of burning a plant and/or a plant part containing SiO₂ and manganese in a weight amount, expressed as elemental manganese, of at least 10 ppm, based on the weight of SiO₂ contained in the plant and/or plant part, so as to obtain the plant ash. According to an embodiment, the process according to the invention further comprises said step (A).

According to an embodiment, the plant part and/or plant, the plant ash, the aqueous silicate solution, and the aqueous slurry further contain phosphorus in a weight amount, expressed as elemental phosphorus, of at least 10 ppm, based on the weight of SiO₂ contained, respectively, in the plant part and/or plant, the plant ash, the aqueous silicate solution, and the aqueous slurry.

The process of the present invention can comprise the step (A) and be free of any step (B) comprising re-burning the plant ash, wherein said step (B) is after step (A) and before step (I).

The process of the present invention can comprise the step (A) and be free of any step (B) comprising washing the plant ash with a liquid containing water or acidified water, wherein said step (B) is after step (A) and before step (I). It can comprise the step (A) and be free of any step (B) comprising acid leaching and/or or acid wetting the plant ash, wherein said step (B) is after step (A) and before step (I). It can comprise the step (A) and be free of any step (B) comprising at least one of (i) washing the plant ash with a liquid containing water or acidified water and (ii) acid leaching and/or acid wetting the plant ash, wherein said step (B) is after step (A) and before step (I). Washing the plant ash with a liquid containing water or acidified water, acid leaching the plant ash and acid wetting the plant ash are operations that would otherwise generally result in a partial or full removal of the manganese and/or phosphorus (where present) from the plant ash.

According to a particularly preferred embodiment, the process of the present invention comprises the step (A) and is free of any step (B) of removing part or all of the manganese and/or phosphorus (where present) from the plant ash, wherein said step (B) is after step (A) and before step (I).

The process of the present invention can comprise the step (A) and be free of any step (B′) comprising washing the plant and/or plant part with a liquid containing water or acidified water, wherein said step (B′) is before step (A). It can comprise the step (A) and be free of any step (B′) comprising acid leaching and/or or acid wetting the plant and/or plant part, wherein said step (B′) is before step (A). It can comprise the step (A) and be free of any step (B′) comprising at least one of (i) washing the plant and/or plant part with a liquid containing water or acidified water and (ii) acid leaching and/or acid wetting the plant and/or plant part, wherein said step (B′) is before step (A) and before step (I). Washing the plant and/or plant part with a liquid containing water or acidified water, acid leaching the plant and/or plant part and acid wetting the plant and/or plant part would otherwise generally result in a partial or full removal of the manganese and/or phosphorus (where present) from the plant and/or plant part.

According to another embodiment, the process of the present invention can also be free of any step (B′) of removing part or all of the manganese and/or phosphorus (where present) from the plant and/or plant part, wherein said step (B′) is before step (A).

According to a still more preferred embodiment, the process of the present invention (i) comprises the step (A), (ii) is free of any step (B) of removing part or all of the manganese and/or phosphorus (where present) from the plant ash, and (iii) is free of any step (B′) of removing part or all of the manganese and/or phosphorus (where present) from the plant and/or plant part, wherein said step (B) is after step (A) and before step (I) and wherein said step (B′) is before step (A).

According to another embodiment, the process of the invention further comprises the steps of:
(III) filtering the aqueous slurry obtained after step (II), using preferably a filter press, so as to obtain a filter cake comprising SiO₂ in particulate form;
(IV) optionally, washing the filter cake with a liquid containing water;
(V) liquefying the filter cake into a flowable aqueous suspension comprising SiO₂ in particulate form, by adding a liquid containing water to the filter cake and, optionally in addition, by subjecting the filter cake to a mechanical and/or chemical treatment;
(VI) drying the flowable aqueous suspension, preferably by means of a spray-dryer, so as to obtain the precipitated silica.

The process of the invention is advantageously free of any step (B″), after step (VI), comprising washing the precipitated silica with a liquid containing water or acidified water. The process of the invention is also advantageously free of any step (B″), after step (VI), comprising acid leaching the precipitated silica and/or acid wetting the precipitated silica. Washing the precipitated silica with a liquid containing water or acidified water, acid leaching the precipitated silica and acid wetting the precipitated silica would otherwise generally result in a partial or full removal of the manganese and/or phosphorus (where present) from the precipitated silica.

Preferably, the process of the invention is free of any step (B″), after step (VI), of removing part or all of the manganese and/or phosphorus (where present) from the precipitated silica.

Furthermore, the invention further concerns a precipitated silica containing SiO₂ in particulate form and manganese in a weight amount, expressed as elemental manganese, ranging from 10 ppm to 75 ppm, based on the weight of SiO₂ contained in the precipitated silica.

Preferably, said precipitated silica further contains phosphorus in a weight amount, expressed as elemental phosphorus, of at least 10 ppm, based on the weight of SiO₂ contained in the precipitated silica. According to a preferred embodiment said precipitated silica is obtainable or obtained according to the process of the present invention.

Furthermore, the invention concerns the use of a precipitated silica for the manufacture of at least one of (i) a precipitated silica-filled elastomeric composition, (ii) a tire part comprising (possibly, composed of) a precipitated silica-filled elastomeric composition and (iii) a tire comprising at least one part comprising (possibly, composed of) a precipitated silica-filled elastomeric composition, wherein said precipitated silica contains SiO₂ in particulate form and manganese in a weight amount, expressed as elemental manganese, ranging from 10 ppm to 75 ppm, based on the weight of SiO₂ contained in the precipitated silica. Similarly, the invention concerns a method for the manufacture of at least one of (i) a precipitated silica-filled elastomeric composition, (ii) a tire part comprising (possibly, composed of) a precipitated silica-filled elastomeric composition and (iii) a tire comprising at least one part comprising (possibly, composed of) a precipitated silica-filled elastomeric composition, said method comprising mixing at least one elastomer with a precipitated silica, wherein said precipitated silica contains SiO₂ in particulate form and manganese in a weight amount, expressed as elemental manganese, ranging from 10 ppm to 75 ppm, based on the weight of SiO₂ contained in the precipitated silica. Preferably, said precipitated silica further contains phosphorus in a weight amount, expressed as elemental phosphorus, of at least 10 ppm, based on the weight of SiO₂ contained in the precipitated silica. According to a preferred embodiment said precipitated silica is obtainable or obtained according to the process of the present invention.

The invention further relates to a precipitated silica-filled elastomeric composition comprising at least one elastomer and said precipitated silica, to a tire part comprising (possibly, composed of) said precipitated silica-filled elastomeric composition, and to a tire comprising at least one part comprising (possibly, composed of) said precipitated silica-filled elastomeric composition.

The invention also relates to a vehicle comprising said tire. The vehicle can be an automotive vehicle, for example a car, a van, a mobile home, a bus, a coach, a truck or a construction machine (such as a backhoe-loader or a dumper); alternatively, the vehicle can be a non-automotive vehicle (such as a trailer or a cart).

The present invention solves the aforementioned problems of the prior art by providing a process for preparing a precipitated silica from a plant ash which not only is environmentally friendly but also economically advantageous. In fact, the process of the invention does not necessitate any pre-treatment of the plant, plant part and/or plant ash or of any post-treatment of the precipitated silica, and, in particular, of any washing step, to efficiently prepare a precipitated silica having the desired properties. Indeed, the precipitated silica obtainable or obtained by the process of the invention can advantageously be employed for the manufacture of precipitated silica-containing elastomeric compositions and tires with the desired characteristics in terms of performance and mechanical and dynamic properties.

### DESCRIPTION OF THE INVENTION

Before the issues of the invention are described in detail, the following should be considered:

It is to be understood that this invention is not limited to particular embodiments described, since such embodiments may of course vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “a compound” means on compound or more than one compound.

The terms “comprising”, “comprises”, and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists”, and “consists of”.

Throughout this application, the term “about” is used to indicate that a value includes the standard deviation of error for the device or method being employed to determine the value.

As used herein, the term “average” refers to number average unless indicated otherwise.

As used herein, the terms “% by weight”, “wt.-%”, “weight percentage”, or “percentage by weight”, are used interchangeably. The same applies to the terms “% by volume”, “vol.-%”, “volume percentage”, or “percentage by volume”, or “% by mol”, “mol-%”, “mol percentage”, or “percentage by mol”.

As used herein, the terms “% % by weight” or “wt.-% o” are used interchangeably to indicate the “per mille” (i.e. “per thousand”) amount. The same applies to the terms “% % by volume”, “vol.-% %”, or “% % by mol”, “mol-% o”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75, and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

“X is substantially free of Y”, a term of art in patent law, is used herein under its usual, commonly accepted meaning, allowing for a possible presence of Y in X as long as the amount, if any, of Y in X does not materially affect the basic characteristics of X. In the context of the present invention, the basic characteristics of a precipitated silica are the physical parameters determined in table 4 and the end use properties determined in tables 6-8.

“X is essentially free of Y”, another term of art in patent law, is also used herein under its usual meaning, allowing a possible, unavoidable presence of traces, such as impurities, of Y in X, which traces should be avoided as far as possible.

For the avoidance of doubt, “X is free of Y” is merely intended to mean that X is completely free of Y.

As used herein, the term “manganese” encompasses manganese in any form that is contained in a precipitated silica, notably manganese in at least one form selected from the group consisting of: manganese element, manganese at the surface of SiO₂ particles, manganese inserted in SiO₂ particles, manganese silicate, and manganese oxide in any oxidation state.

The weight amount of manganese, for the purposes of the present invention, is expressed as elemental manganese throughout the whole specification.

As used herein, the term “phosphorus” is intended to denote phosphorus in any form that is contained in the precipitated silica, notably phosphorus in at least one form selected from the group consisting of: phosphorus element, phosphorus at the surface of SiO₂ particles, phosphorus inserted in SiO₂ particles, orthophosphate ion, polyphosphate ion, and phosphides.

The weight amount of phosphorus, for the purposes of the present invention, is expressed as elemental phosphorus throughout the whole specification.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different alternatives, embodiments, and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures, or characteristics described in the present description may be combined in any suitable manner, as would be apparent to a person skilled in the art from this disclosure, in one or more embodiments. Furthermore, while some embodiments described herein include some but not other features included in other embodiments, combinations of features of different embodiments are mean to be within the scope of the invention, and form different embodiments, as would be understood by those in the art.

The present invention refers to a process for producing a precipitated silica from a plant ash, wherein the process comprises the steps of:
(I) reacting a plant ash containing SiO₂ and manganese in a weight amount, expressed as elemental manganese, of at least 10 ppm, based on the weight of SiO₂ contained in the plant ash, with an alkali metal base, preferably an alkali metal hydroxide, at a temperature of at least 100° C. in an aqueous reaction medium, so as to obtain an aqueous silicate solution comprising (i) SiO₂ in the form of silicate anions and (ii) manganese in a weight amount, expressed as elemental manganese, of at least 10 ppm, based on the weight of SiO₂ contained in the silicate solution, and
(II) reacting the aqueous silicate solution with an acidifying agent at a temperature of at least 40° C. in an aqueous reaction medium having a pH that exceeds 7.0 during at least part of the duration of the reaction, so as to achieve precipitation of SiO₂ and produce an aqueous slurry comprising SiO₂ in particulate form and manganese in a weight amount, expressed as elemental manganese, of at least 10 ppm, based on the weight of SiO₂ contained in the aqueous slurry.

According to a preferred embodiment, said plant ash contains manganese in a weight amount, expressed as elemental manganese, of at least 15 ppm, at least 18 ppm, at least 20 ppm, at least 50 ppm, at least 100 ppm or at least 200 ppm, based on the weight of SiO₂ contained in the plant ash. More preferably, said plant ash contains manganese in a weight amount, expressed as elemental manganese, of at least 500 ppm, based on the weight of SiO₂ contained in the plant ash. Still more preferably, said plant ash contains manganese in a weight amount, expressed as elemental manganese, of at least 1000 ppm, based on the weight of SiO₂ contained in the plant ash. The most preferably, said plant ash contains manganese in a weight amount, expressed as elemental manganese, of at least 2000 ppm, based on the weight of SiO₂ contained in the plant ash.

Advantageously, said plant ash contains manganese in a weight amount, expressed as elemental manganese, of at most 15000 ppm, preferably of at most 12000 ppm, more preferably of at most 9000 ppm, still more preferably of at most 7000 ppm, even more preferably of at most 5000 ppm and the most preferably of at most 3500 ppm, based on the weight of SiO₂ contained in the plant ash. In some particular instances, said plant ash may contain manganese in a lower weight amount, e.g. in weight amount, expressed as elemental manganese, of at most 2500 ppm, at most 1250 ppm or at most 675 ppm, based on the weight of SiO₂ contained in the plant ash.

In some embodiments, said plant ash contains manganese in a weight amount, expressed as elemental manganese, ranging from 10 ppm to 5000 ppm, based on the weight of SiO₂ contained in the plant ash.

According to a preferred embodiment of the invention, said aqueous silicate solution contains manganese in a weight amount, expressed as elemental manganese, of at most 500 ppm, preferably of at most 375 ppm, more preferably of at most 250 ppm, still more preferably of at most 200 ppm, even more preferably of at most 150 ppm and the most preferably of at most 100 ppm, based on the weight of SiO₂ contained in the aqueous silicate solution.

In some particular instances, said aqueous silicate solution may contain manganese in a lower weight amount, e.g. in a weight amount, expressed as elemental manganese, of at most 75 ppm, of at most 50 ppm, of at most 30 ppm, of at most 25 ppm.

Besides, said aqueous silicate solution contains manganese in a weight amount, expressed as elemental manganese, that is preferably of at least 10 ppm, more preferably of at least 30 ppm and still more preferably of at least 50 ppm, based on the weight of SiO₂ contained in the aqueous silicate solution.

In some particular instances, said aqueous silicate solution may contain manganese in a weight amount, expressed as elemental manganese, ranging from 10 ppm to 100 ppm, from 10 ppm to 80 ppm, from 10 ppm to 75 ppm, from 15 ppm to 50 ppm or from 18 ppm to 25 ppm, based on the weight of SiO₂ contained in the aqueous silicate solution.

According to an embodiment of the invention, the aqueous slurry obtained in step (II) contains manganese in the same amounts as those disclosed for the aqueous silicate solution.

According to an embodiment of the invention, during step (I), the plant ash is reacted with the alkali metal base at a temperature of at least 120° C., preferably of at least 140° C. and more preferably of at least 160° C. Besides, step (I) is carried out at a temperature advantageously of at most 250° C., preferably of at most 220° C. and more preferably of at most 200° C. Good results were obtained when the plant ash was reacted with the alkali metal base at a temperature ranging from 140° C. to 220° C., preferably from 160° C. to 200° C.

Preferably said alkali metal base, is selected from the group consisting of: tetraalkylammonium hydroxide (NR₄⁺, OH⁻) where R is an alkyl chain, preferably a C₁-C₄ alkyl chain, a base containing sodium or potassium, or a combination thereof. More preferably said alkali metal base is an alkali metal hydroxide selected from sodium or potassium hydroxide.

According to a particularly preferred embodiment, the process according to the present invention comprises a step (A), before step (I) of burning a plant and/or a plant part so as to obtain the plant ash, wherein said plant and/or plant part contains SiO₂ and manganese in a weight amount, expressed as elemental manganese, which is the same as disclosed above for the plant ash, based on the weight of SiO₂ contained in the plant and/or plant part. In other words, said plant ash is obtained from a combustion of a plant and/or a plant part.

Preferably, said plant and/or plant part contains manganese in a weight amount, expressed as elemental manganese, of at least 15 ppm, at least 18 ppm, at least 20 ppm, at least 50 ppm, at least 100 ppm or at least 200 ppm, based on the weight of SiO₂ contained in the plant and/or plant part. More preferably, said plant and/or plant part contains manganese in a weight amount, expressed as elemental manganese, of at least 500 ppm, based on the weight of SiO₂ contained in the plant and/or plant part. Still more preferably, said plant and/or plant part contains manganese in a weight amount, expressed as elemental manganese, of at least 1000 ppm, based on the weight of SiO₂ contained in the plant and/or plant part. The most preferably, said plant and/or plant part contains manganese in a weight amount, expressed as elemental manganese, of at least 2000 ppm, based on the weight of SiO₂ contained in the plant and/or plant part.

Advantageously, said plant and/or plant part contains manganese in a weight amount, expressed as elemental manganese, of at most 15000 ppm, preferably of at most 12000 ppm, more preferably of at most 9000 ppm, still more preferably of at most 7000 ppm, even more preferably of at most 5000 ppm and the most preferably of at most 3500 ppm, based on the weight of SiO₂ contained in the plant and/or plant part. In some particular instances, said plant and/or plant part may contain manganese in a lower weight amount, e.g. in weight amount, expressed as elemental manganese of at most 2500 ppm, of at most 1250 ppm or of at most 675 ppm, based on the weight of SiO₂ contained in the plant and/or plant part.

According to a particularly preferred embodiment of the invention, said plant and/or plant part contains manganese in a weight amount, expressed as elemental manganese, ranging from 10 ppm to 5000 ppm, preferably from 15 ppm to 2500 ppm, more preferably from 18 ppm to 1250 ppm, even more preferably from 18 ppm to 675 ppm, based on the weight of SiO₂ contained in the plant and/or plant part.

According to an embodiment of the present invention, the plant and/or plant part, the plant ash, the aqueous silicate solution, and/or the aqueous slurry further contain phosphorus. The plant and/or plant part may contain phosphorus in a weight amount, expressed as elemental phosphorus, of at least 10 ppm, at least 15 ppm or at least 20 ppm, based on the weight of SiO₂ contained in plant and/or plant part.

Advantageously, the plant and/or plant part further contains phosphorus in a higher weight amount, e.g. in a weight amount, expressed as elemental phosphorus, of at least 500 ppm, preferably of at least 1000 ppm, more preferably of at least 1500 ppm and still more preferably of at least 1650 ppm, at least 1700 ppm or at least 1750 ppm, based on the weight of SiO₂ contained in plant and/or plant part.

Preferably, the plant and/or plant part contains phosphorus in a weight amount, expressed as elemental phosphorus, of at most 5000 ppm, more preferably of at most 3500 ppm, still more preferably of at most 2500 ppm, and the most preferably of at most 2000 ppm, based on the weight of SiO₂ contained in plant and/or plant part.

In some particular instances, the plant and/or plant part contains phosphorus in a weight amount, expressed as elemental phosphorus, that is of at most 1250 ppm or of at most 675 ppm, based on the weight of SiO₂ contained in the plant and/or plant part.

According to an embodiment of the invention, the plant and/or plant part contains phosphorus in a weight amount, expressed as elemental phosphorus, ranging from 10 ppm to 5000 ppm, or from 15 ppm to 2500 ppm, or from 20 ppm to 1250 ppm, based on the weight of SiO₂ contained in the plant and/or plant part.

Analogously, the plant ash, the aqueous silicate solution, and/or the aqueous slurry may further contain phosphorus in a weight amount, expressed as elemental phosphorus, of at least 10 ppm, at least 15 ppm or at least 20 ppm, based on the weight of SiO₂ contained, respectively, in the plant ash, the aqueous silicate solution, and/or the aqueous slurry.

Advantageously, the plant ash, the aqueous silicate solution, and/or the aqueous slurry contain phosphorus in a higher weight amount, e.g. in a weight amount, expressed as elemental phosphorus, of at least 500 ppm, preferably of at least 1000 ppm, more preferably of at least 1500 ppm and still more preferably of at least 1650 ppm, at least 1700 ppm or at least 1750 ppm, based on the weight of SiO₂ contained, respectively, in the plant ash, the aqueous silicate solution, and/or the aqueous slurry. In addition, the aqueous silicate solution and/or the aqueous slurry contain phosphorus in a weight amount, expressed as elemental phosphorus, that is even more preferably of at least 2000 ppm and the most preferably of at least 2500 ppm, based on the weight of SiO₂ contained, respectively, in the aqueous silicate solution, and/or the aqueous slurry.

Preferably, the plant ash, the aqueous silicate solution, and/or the aqueous slurry contain phosphorus in a weight amount, expressed as elemental phosphorus, of at most 5000 ppm, more preferably of at most 3500 ppm and still more preferably of at most 3000 ppm, based on the weight of SiO₂ contained, respectively, in the plant ash, the aqueous silicate solution, and/or the aqueous slurry. In addition, the plant ash contains phosphorus in a weight amount expressed as elemental phosphorus, that is even more preferably of at most 2500 ppm and the most preferably of at most 2000 ppm, based on the weight of SiO₂ contained in the plant ash.

In some particular instances, the plant ash, the aqueous silicate solution, and/or the aqueous slurry contain phosphorus in a weight amount expressed as elemental phosphorus, of at most 1250 ppm or of at most 675 ppm, based on the weight of SiO₂ contained, respectively, in the plant ash, the aqueous silicate solution, and/or the aqueous slurry.

According to an embodiment of the invention, the plant ash, the aqueous silicate solution, and/or the aqueous slurry contain phosphorus in a weight amount expressed as elemental phosphorus, ranging from 10 ppm to 5000 ppm, or from 15 ppm to 2500 ppm, or from 20 ppm to 1250 ppm, based on the weight of SiO₂ contained, respectively, in the plant ash, the aqueous silicate solution, and/or the aqueous slurry.

According to an embodiment of the invention, the aqueous slurry obtained in step (II) preferably contains phosphorus in the same amounts as those disclosed for the aqueous silicate solution.

Without wishing to be bound to a specific theory of mechanism, it has been found that the weight amount of manganese and, where present, of phosphorus contained in the plant and/or plant part and, in turn, contained in the plant ash as described above does not have any negative impact on the preparation of the aqueous silicate solution and on the preparation of the precipitated silica and on its properties.

Analogously, it has also been found that the presence of manganese and, where present, of phosphorus, contained in the aqueous silicate solution also does not have an impact on the preparation of the precipitated silica and on its properties.

Additionally, it has been found that, for the purposes of the present invention, it is not necessary to treat either the plant and/or plant part or the plant ash to remove the manganese and, where present, the phosphorus, contained therein as the presence of manganese and, where present, of phosphorus, in the weight amounts described above does not have a negative impact on the properties of the precipitated silica.

Hence, according to an embodiment, the process of the invention can comprise the step (A) and be free of any step (B) after step (A) and before step (I) comprising re-burning the plant ash.

It is understood that the plant ash used at step (I) that has not been subjected to any step (B), after step (A) and before step (I), comprising re-burning the plant ash still contains unburnt carbon in a substantial amount.

Then, according to an embodiment, the plant ash used at step (I) comprises carbon in a substantial amount. Just to figure out what this amount can be, the Applicant noted that an exemplary unwashed RHA to which no step (B) had been applied had a carbon content, as determined by C/S analysis, of 11 wt.-%, based on the total weight of the RHA; this exemplary RHA had obviously a black color. Accordingly, the plant ash used at step (I) can be black.

According to an embodiment, the process of the invention can comprise the step (A) and can be free of any step (B) after step (A) and before step (I) comprising washing the plant ash with a liquid containing water or acidified water.

According to an embodiment, the process of the invention can comprise the step (A) and be free of any step (B) after step (A) and before step (I) comprising acid leaching and/or acid wetting the plant ash.

Preferably said acid leaching and/or acid wetting is performed with an acidifying agent, more preferably with HCl, even more preferably with a 1N or 6N HCl solution.

According to an embodiment, said acid leaching can be performed by treating the plant ash under reflux with said acidifying agent, preferably with HCl, even more preferably with a 1N or 6N HCl, for at least 1 hour, preferably for at least 1.5 hours.

Said acid wetting is preferably performed by soaking the plant ash in said acidifying agent, preferably HCl, more preferably 1N or 6N HCl solution, for at least 1 hour, preferably for at least 3 hours, more preferably from 3 to 7 hours.

According to an embodiment, the process of the invention can comprise the step (A) and be free of any step (B) after step (A) and before step (I) comprising at least one of (i) washing the plant ash with a liquid containing water or acidified water and (ii) acid leaching and/or acid wetting the plant ash.

Washing the plant as with a liquid containing water or acidified water, acid leaching the plant ash and acid wetting the plant ash are operations that would otherwise generally result in a partial or full removal of the manganese and/or, where present, phosphorus from the plant ash.

According to a particularly preferred embodiment, the process of the invention comprises the step (A) and is free of any step (B) after step (A) and before step (I) of removing part or all of the manganese and/or, where present, phosphorus from the plant ash.

According to the invention, said step (B) according to any of the above embodiments can be considered as a step of pre-treating the plant ash.

According to another particularly preferred embodiment, the process of the invention can comprise the step (A) and be free of any step (B′) before step (A) comprising washing the plant and/or plant part with a liquid containing water or acidified water.

According to an embodiment, the process of the invention can comprise the step (A) and be free of any step (B′) before step (A) comprising acid leaching and/or acid wetting the plant and/or plant part.

Preferably said acid leaching and/or acid wetting is as defined above for step (B).

According to an embodiment, the process of the invention can comprise the step (A) and be free of any step (B′) before step (A) comprising at least one of (i) washing the plant and/or plant part with a liquid containing water or acidified water and (ii) acid leaching and/or acid wetting the plant and/or plant part.

Washing the plant and/or plant part with a liquid containing water or acidified water, acid leaching the plant and/or plant part and acid wetting the plant and/or plant part would otherwise generally result in a partial or full removal of the manganese and/or, where present, phosphorus, from the plant and/or plant part.

According to a particularly preferred embodiment, the process of the invention comprises the step (A) and is free of any step (B′) of removing part or all of the manganese and/or, where present, phosphorus, from the plant and/or plant part. According to the invention, said step (B′) can be considered as a step of pre-treating the plant and/or plant part.

According to the invention, the plant ash that has not been subjected to any step (B) according to any of the embodiments as described above is considered as an untreated plant ash, preferably an unwashed and/or not re-burnt plant ash.

Analogously, according to the invention, the plant and/or plant part that has not been subjected to any step (B′) according to any of the embodiments as described above is considered an untreated plant and/or plant part, preferably an unwashed plant and/or part.

Without wishing to be bound to a specific theory, it has been found that the process according to the present invention does not necessitate any pre-treatment of the plant, plant part and/or plant ash to remove the manganese and, where present, the phosphorus, contained therein. On the contrary, it has been surprisingly found that the presence of said manganese and/or, where present, phosphorus, in the plant, plant part and/or plant ash do not affect the synthesis of precipitated silica and that, in turn, the precipitated silica so-obtained still possess the desired mechanical and rheological properties, which are particular advantageous for tire applications.

According to the invention, the plant is preferably an angiosperm, more preferably a monocot or cudicot, most preferably a plant belonging to the family selected from the group consisting of Poaceae, Equisetaceae, Cyperaceae, Cucurbitaceac, Cannabaceac, Arecaceac, Brassicaceac, and combinations thereof.

According to an embodiment of the invention, the plant is a tree. Preferably, the tree is selected from the group consisting of: pine, oak, birch, elm, and combinations thereof.

Preferably, the plant belonging to the family of Poaceae is selected from the group consisting of: rice, wheat, sugar cane, bamboo, oat, barley, rye, sorghum, triticale, reed canary grass, reed, corn, miscanthus, and combinations thereof.

Preferably, the plant belonging to the family of Equisetaceae is field horsetail.

Preferably, the plant belonging to the family of Cyperaceae is sedge.

Preferably, the plant belonging to the family of Cucurbitaceac is selected from the group consisting of: melon, watermelon, squash, cucumber, and combinations thereof.

Preferably, the plant belonging to the family of Cannabaccac is hemp.

Preferably, the plant belonging to the family of Arecaceac is palm trec.

Preferably, the plant belonging to the family of Brassicaceae is rapeseed.

It is preferred that the silica-containing plant (SiO₂-containing plant) is a plant selected from the group consisting of rice, wheat, rapeseed, barley, bamboo, field horsetail, sedge, watermelon, and combinations thereof.

Preferably, said plant part is selected from the group consisting of: a root, a stem, a leaf, a flower, a fruit, a husk, a culm, a stalk, wood, and combinations thereof.

According to the invention, the plant part can also derive from a processing of the plant, such as straw (e.g. cereals straw), bagasse (e.g. sugar cane bagasse), oil (e.g. palm oil), sawdust (e.g. tree sawdust), and/or pellet.

It is preferred that said plant part is selected from the group consisting of: rice husk, rice straw, wheat husk, wheat straw, barley straw, barley husk, sugar cane bagasse, sugar cane leaves, bamboo stem, bamboo leaves, corncob, palm tree oil, miscanthus stalk, miscanthus leaves, sedge leave, watermelon fruit, tree wood, and combinations thereof.

In a particularly preferred embodiment of the invention, the plant is rice and, preferably, the plant part is a husk.

According to the invention, the combustion of the plant and/or plant part (step A) described above) is carried out by conventional techniques by burning a part of a plant and/or a plant containing silica.

In an embodiment, the combustion of the plant and/or plant part is carried out at a temperature from 300 to 1500° C., preferably from 500 to 1000° C. According to an embodiment, the combustion of the plant and/or plant part is carried out at a temperature above 700° C., preferably at a temperature from more than 700° C. up to 1000° C. According to another embodiment, the combustion of the plant and/or plant part is carried out at a temperature of at most 700° C., preferably at a temperature from 500° C. to 700° C.

According to the invention, the acidifying agent of step (II) described above is selected from the group consisting of: a mineral acid, preferably selected from the group consisting of: sulfuric acid (H₂SO₄), hydrochloric acid (HCl), nitric acid (HNO₃), phosphoric acid (H₃PO₄), and combinations thereof and an organic acid, preferably selected from the group consisting of: acetic acid, formic acid, carbonic acid, and combinations thereof.

According to the invention, step (II) of the process described above is carried out in an aqueous reaction medium having a pH that exceeds 7.0 during at least part of the duration of the reaction, preferably during at least 25% of the duration of the reaction, more preferably during at least 28% of the reaction and still more preferably during at least 33% of the duration of the reaction. In some embodiments, step (II) of the process described above is carried out in an aqueous reaction medium having a pH that exceeds 7.0 during at most 66% of the duration of the reaction, preferably during at most 50% of the reaction; in some other embodiments, step (II) of the process described above is carried out in an aqueous reaction medium having a pH that exceeds 7.0 during more than 50% of the duration of the reaction, preferably during at least 90% of the duration of the reaction, more preferably during at least 95% of the duration of the reaction and still more preferably during the whole duration of the reaction.

Preferably, step (II) of reacting the aqueous silicate solution with the acidifying agent is carried out at a temperature of at least 50° C., more preferably of at least 60° C., still more preferably of at least 75° C. and the most preferably of at least 80° C. Besides, step (II) is carried out at a temperature advantageously of at most 150° C., preferably of less than 100° C. and more preferably of at most 95° C. Good results were obtained when step (II) was carried out at a temperature ranging from 60° C. up to less than 100° C. Excellent results were obtained when step (II) was carried out at a temperature ranging from 75° C. up to 95° C.

Preferably, the aqueous reaction medium of step (I) and/or (II) of the process of the invention is water.

According to the invention, the process can further comprise the steps of:
(III) filtering the aqueous slurry obtained after step (II), using preferably a filter press, so as to obtain a filter cake comprising SiO₂ in particulate form;
(IV) optionally, washing the filter cake with a liquid containing water;
(V) liquefying the filter cake into a flowable aqueous suspension comprising SiO₂ in particulate form, by adding a liquid containing water to the filter cake;
(VI) drying the flowable aqueous suspension, preferably by means of a spray-dryer, so as to obtain the precipitated silica.

According to an embodiment of the invention, step (V) further comprises subjecting the filter cake to a mechanical and/or chemical treatment (in addition to adding a liquid containing water to the filter cake).

According to an embodiment, the process of the present invention is free of any step (B″) after step (VI) comprising washing the precipitated silica with a liquid containing water or acidified water.

According to an embodiment, the process of the invention is free of any step (B″) after step (VI) comprising acid leaching and/or acid wetting the precipitated silica.

Preferably said acid leaching and/or acid wetting is as defined above for steps (B) and (B′).

According to an embodiment, the process of the invention is free of any step (B″) after step (VI) comprising at least one of (i) washing the precipitated silica with a liquid containing water or acidified water and (ii) acid leaching and/or acid wetting the precipitated silica.

Washing the precipitated silica with a liquid containing water or acidified water, acid leaching the precipitated silica and acid wetting the precipitated silica would otherwise generally result in a partial or full removal of the manganese and/or, where present, of part or all of the phosphorus from the precipitated silica.

According to a particularly preferred embodiment, the process according to the present invention is free of any step (B″), after step (VI), of removing part or all of the manganese and/or, where present, of part or all of the phosphorus from the precipitated silica.

According to the invention, said step (B″) can be considered as a step of post-treating the precipitated silica.

According to an embodiment, the process according to the present invention does not involve (i.e., is free of) a step of forming a xerogel.

According to the invention, the precipitated silica obtained at the end of the process described above can also contain other elements (deriving from the synthesis and, in particular, from the use of untreated plant ashes and untreated plant and/or plant part), selected from the group consisting of: Al, As, Ca, Cd, Co, Cr, Cu, Fe, Hg, Mg, Ni, Pb, S, Sb, Ti, Zn, K, Na, and combination thereof.

The present invention also relates to a precipitated silica that contains SiO₂ in particulate form and manganese in a weight amount, expressed as elemental manganese, ranging from 10 ppm to 75 ppm, based on the weight of SiO₂ contained in the precipitated silica. The present invention also relates to the use of said precipitated silica for the manufacture of a precipitated silica-filled elastomeric composition.

Preferably, said precipitated silica contains manganese in a weight amount, expressed as elemental manganese, of at least 10 ppm, preferably of at least 15 ppm, more preferably of at least 18 ppm, based on the weight of SiO₂ contained in the precipitated silica.

Preferably, said precipitated silica contains manganese in a weight amount, expressed as elemental manganese, of at most 75 ppm, preferably of at most 50 ppm, more preferably of at most 30 ppm, even more preferably of at most 25 ppm, based on the weight of SiO₂ contained in the precipitated silica.

According to a particularly preferred embodiment of the invention, said precipitated silica contains manganese in a weight amount, expressed as elemental manganese, ranging from 15 ppm to 50 ppm, preferably from 18 ppm to 30 ppm, more preferably from 18 ppm to 25 ppm, based on the weight of SiO₂ contained in the precipitated silica.

Preferably, said precipitated silica further contains phosphorus in a weight amount, expressed as elemental phosphorus, of at least 10 ppm, preferably of at least 15 ppm, more preferably of at least 20 ppm, even more preferably of at least 23 ppm based on the weight of SiO₂ contained in the precipitated silica.

Preferably, said precipitated silica contains phosphorus in a weight amount, expressed as elemental phosphorus, of at most 300 ppm, more preferably of at most 100 ppm, even more preferably of at most 50 ppm, still more preferably of at most 30 ppm, based on the weight of SiO₂ contained in the precipitated silica.

According to an embodiment of the invention, said precipitated silica contains phosphorus in a weight amount, expressed as elemental phosphorus, ranging from 10 ppm to 300 ppm, preferably from 15 ppm to 100 ppm, more preferably from 20 ppm to 50 ppm, even more preferably from 23 ppm to 30 ppm, based on the weight of SiO₂ contained in the precipitated silica.

Preferably, said precipitated silica contains SiO₂ in particulate form in a weight amount of at least 90.0%, more preferably at least 93.0%, even more preferably at least 95.0%, based on the weight of the precipitated silica.

Preferably, said precipitated silica contains SiO₂ in particulate form in a weight amount of at most 99.0%, preferably at most 98.0%, more preferably at least 97.0%, based on the weight of the precipitated silica.

According to an embodiment of the invention, said precipitated silica contains SiO₂ in particulate form in a weight amount ranging from 90.0% to 99.0%, preferably from 93.0% to 98.0%, more preferably from 95.0% to 97.0% based on the weight of the precipitated silica. Preferably, said precipitated is substantially free of SiO₂ particles to which an organic moiety is covalently bound through a Si—C linkage; it may be essentially free or even free of SiO₂ particles to which an organic moiety is covalently bound through a Si—C linkage.

Preferably, said precipitated silica is substantially free, essentially free or even free of SiO₂ particles to which an organic moiety is covalently bound (no matter what the covalent linkage between the SiO₂ particles and the organic moiety could be).

More preferably, said precipitated silica differs from any organically modified precipitated silica.

As used herein, the terms “organically modified precipitated silica” denote a precipitated silica comprising SiO₂ particles and a substantial amount of (i) an organic compound and/or (ii) an organic moiety that is covalently bound to the SiO₂ particles. The organically modified precipitated silica can be a precipitated silica comprising a substantial amount of an organic compound (e.g. polyethylene glycol) that is not covalently bound to SiO₂ particles. The organically modified precipitated silica can be a precipitated silica comprising a substantial amount of an organic moiety that is covalently bound to the SiO₂ particles; such an organically modified precipitated silica results typically from a chemical reaction between an organic compound (e.g. potassium methyl siliconate) and SiO₂ particles. An organically modified precipitated silica thus contains a substantial amount of carbon, notably in the form of the organic compound and/or of the organic moiety. An organically modified precipitated silica may contain at least 0.5%, at least 0.75% or even least 1% of carbon, based on the weight of SiO₂ contained in the modified precipitated silica.

Said carbon is a carbon contained in the aforementioned organic moieties covalently bound to the SiO₂ particles through a Si—C linkage.

In contrast, said precipitated silica is advantageously substantially free, essentially free, or even free of carbon. Its carbon content, as determined by C/S method, ranges advantageously from 0 up to less than 0.5%, preferably from 0 to 4000 ppm, more preferably from 0 to 3000 ppm, still more preferably from 0 to 2000 ppm and even more preferably from 0 to 1000 ppm, based on the weight of SiO₂ contained in the precipitated silica.

According to an embodiment, said precipitated silica has a BET specific surface of at least 165 m²/g, preferably of at least 180 m²/g and more preferably of at least 200 m²/g. According to a preferred embodiment, said precipitated silica has a BET specific surface area of at most 290 m²/g, preferably of at most 280 m²/g, even more preferably ranging from 165 m²/g to 280 m²/g.

According to another embodiment, said precipitated silica has a CTAB specific surface area of at least 155 m²/g, preferably of at least 165 m²/g, more preferably of at least 180 m²/g.

According to a preferred embodiment, the precipitated silica has a CTAB specific surface area of at most 225 m²/g preferably of at most 220 m²/g, even more preferably ranging from 155 m²/g to 220 m²/g.

According to an embodiment, said precipitated silica has a d₅₀ ranging from 20 nm to 200 nm, preferably from 50 nm to 180 nm. According to the invention, said d₅₀ is measured by centrifugal sedimentation, preferably by centrifugal sedimentation in a disc centrifuge using a centrifugal photosedimentometer (CPS).

According to a particularly preferred embodiment, said precipitated silica is obtainable or obtained by the process according to the present invention as described above.

Without wishing to be bound to a specific theory, it has been found that in the plant ash, manganese is deemed to be present notably in one or more forms that are insoluble in a basic medium, that is to say that they cannot be dissolved by an alkali metal base containing sodium, such as NaOH. These ones might include one or more manganese oxides or mixed oxides of manganese with other metals such as aluminum and/or iron. Hence, it can be concluded that this might result in lower values for the manganese content in the aqueous silicate solution than in the plant ash.

Moreover, in the aqueous slurry obtained after step (II), a major amount of manganese is deemed to be present in the aqueous liquid phase of the slurry in the form of manganese ions (Mn2⁺ and/or Mn3⁺). According to an embodiment of the present invention, when the aqueous slurry is filtered according to step (III) to obtain a filter cake, a major amount of such manganese ions thus accompanies the liquid phase of the slurry and get thus separated from the filter cake from which the precipitated silica is obtained. A fortiori, if the filter cake is washed according to an embodiment of the present invention, a certain residual amount of manganese possibly present in the filter cake, e.g., as manganese salts, can be eliminated with the washing. Therefore, without wishing to be bound to a specific theory, it can be concluded that this might result in lower values for the manganese content in the precipitated silica than in the aqueous silicate solution and in the plant ash.

Contrary to manganese, it is deemed that phosphorus is essentially present in the plant ash in one or more forms that are highly soluble in an aqueous basic medium (such as hydrogenophosphate) and which can thus be and are easily extracted by an alkali metal base containing sodium, such as NaOH.

Without wishing to be bound to a specific theory, it can be concluded that the possibly higher phosphorus content in the aqueous silicate solution than in the plant ash according to an embodiment of the present invention, does not involve any phosphorus creation but rather merely reflects the fact that phosphorus is extracted from the plant ash with a better yield than Si. An especially high content of phosphorus content in the silicate may be achieved when an excess amount of plant ash (expressed as SiO₂ content) is used compared to the amount of the alkali metal base containing sodium, such as NaOH.

The present invention also concerns a method for preparing a precipitated silica-filled elastomeric composition, said method comprising mixing at least one elastomer with the precipitated silica as described above.

The present invention also relates to a precipitated silica-filled elastomeric composition comprising at least one elastomer and the precipitated silica as described above.

According to the present invention, the precipitated silica is employed within said precipitated silica-filled elastomeric composition as reinforcing filler.

Preferably, said at least one elastomer has at least one glass transition temperature of from −150 to +300° C., for example from −150 to +20° C.

Notable non-limiting examples of suitable elastomers are diene elastomers. For example, use may be made of elastomers deriving from aliphatic or aromatic monomers, comprising at least one unsaturation such as, in particular, ethylene, propylene, butadiene, isoprene, styrene, acrylonitrile, isobutylene or vinyl acetate, polybutyl acrylate, or their mixtures. Mention may also be made of functionalized elastomers, that is elastomers functionalized by chemical groups positioned along the macromolecular chain and/or at one or more of its ends (for example by functional groups capable of reacting with the surface of the SiO₂ particles), and halogenated polymers. Mention may be made of polyamides, ethylene homo- and copolymer, propylene homo- and copolymer.

Among diene elastomers mention may be made, for example, of polybutadienes (BRs), polyisoprenes (IRs), butadiene copolymers, isoprene copolymers, or their mixtures, and in particular styrene/butadiene copolymers (SBRs, in particular ESBRs (emulsion) or SSBRs (solution)), isoprene/butadiene copolymers (BIRs), isoprene/styrene copolymers (SIRs), isoprene/butadiene/styrene copolymers (SBIRs), ethylene/propylene/diene terpolymers (EPDMs), and also the associated functionalized polymers (exhibiting, for example, pendant polar groups or polar groups at the chain end, which can interact with the SiO₂ particles).

Mention may also be made of natural rubber (NR) and epoxidized natural rubber (ENR).

The precipitated silica-filled elastomeric compositions can be vulcanized with sulfur (vulcanisates are then obtained) or crosslinked, in particular with peroxides or other crosslinking systems (for example diamines or phenolic resins).

The precipitated silica-filled elastomeric composition according to an embodiment of the present invention can also comprise at least one coupling agent and/or at least one covering agent and/or at last an antioxidant.

Use may particularly be made, as coupling agents, of “symmetrical” or “unsymmetrical” silane polysulfides; mention may more particularly be made of bis((C₁-C₄)alkoxyl(C₁-C₄)alkylsilyl(C₁-C₄)alkyl) polysulfides (in particular disulfides, trisulfides or tetrasulfides) such as, for example, bis(3-(trimethoxysilyl)propyl) polysulfides or bis(3-(triethoxysilyl)propyl) polysulfides, such as triethoxysilylpropyl tetrasulfide.

Mention may also be made of monoethoxydimethylsilylpropyl tetrasulfide.

Mention may also be made of silanes comprising masked or free thiol functional groups.

The coupling agent can be grafted beforehand to the elastomer. It can also be employed in the free state or grafted at the surface of the SiO₂ particles.

The coupling agent can optionally be combined with an appropriate “coupling activator”, that is to say a compound which, mixed with this coupling agent, increases the effectiveness of the latter.

The amount of precipitated silica which can be employed within said precipitated silica-filled elastomeric composition can range within a fairly wide range. It normally represents from 10% to 200% by weight, in particular from 20% to 150% by weight, especially from 20% to 80% by weight, for example from 30% to 70% by weight of the amount of the at least one elastomer. Alternatively, proportion by weight of the precipitated silica of the invention in the precipitated silica-filled elastomeric composition can be from 80% to 120% by weight, for example from 90% to 110% by weight, of the amount of the at least one elastomer.

The precipitated silica as described above can advantageously constitute all of the reinforcing inorganic filler and even all of the reinforcing filler of the elastomeric composition.

The precipitated silica as described above can optionally be combined with at least one other reinforcing filler, such as, in particular, a commercial highly dispersible silica, such as, for example, Zeosil® 1165, Zeosil® 1115 MP or Zeosil® 1085 MP precipitated silica (commercially available from Solvay); another reinforcing inorganic filler, such as, for example, alumina, indeed even a reinforcing organic filler, in particular carbon black (optionally covered with an inorganic layer, for example of SiO₂).

The precipitated silica then preferably constitutes at least 50% by weight, indeed even at least 80% by weight, of the total amount of the reinforcing filler.

This precipitated silica-filled elastomeric composition can be used for the manufacture of a tire part. So that another object of the present invention is the use of the precipitated silica-filled elastomeric composition as described above for the manufacture of a tire part comprising (possibly, composed of) said precipitated silica-filled elastomeric composition.

The present invention also relates to a method for the manufacture of a tire part comprising (possibly, composed of) said precipitated silica-filled elastomeric composition, wherein said method comprises (i) mixing at least one elastomer with the precipitated silica as described above so as to obtain the precipitated silica-filled elastomeric composition described above and (ii) shaping the so-obtained precipitated silica-filled elastomeric composition into the tire part.

Another object of the present invention is said tire part comprising (possibly, composed of) the precipitated silica-filled elastomeric composition as described above. Preferably said tire part is a tire tread.

The present invention also relates to the use of the precipitated silica-filled elastomeric composition as described above for the manufacture of a tire comprising at least one part comprising (possibly, composed of) a precipitated silica-filled elastomeric composition as described above (i.e. the tire part according to the present invention).

The invention also concerns a method for the manufacture of a tire comprising at least one part comprising (possibly, composed of) the precipitated silica-filled elastomeric composition as described above (i.e. the tire part according to the present invention), wherein said method comprises (i) mixing at least one elastomer with the precipitated silica as described above so as to obtain the precipitated silica-filled elastomeric composition as described above, (ii) shaping the so-obtained precipitated silica-filled elastomeric composition into a tire part comprising (possibly, composed of) the precipitated silica-filled elastomeric composition and (iii) assembling the so-shaped tire part comprising (possibly, composed of) the precipitated silica-filled elastomeric composition with at least one tire part other than the tire part comprising (possibly, composed of) the precipitated silica-filled elastomeric composition so as to obtain the tire.

The present invention also relates to a tire comprising the tire part comprising (possibly, composed of) the precipitated silica-filled elastomeric composition as described above and a vehicle comprising said tire.

The present invention further relates to a precipitated silica obtainable or obtained by the process described above and its use/method for the manufacture of (i) a precipitated silica-filled elastomeric composition, (ii) a tire part comprising (possibly, composed of) a precipitated silica-filled elastomeric composition and/or (iii) a tire comprising at least one part comprising (possibly, composed of) a precipitated silica-filled elastomeric composition, and to said precipitated silica-filled elastomeric composition, tire part, tire and/or vehicle as described in any of the embodiments described above.

Should the disclosure of any patents, patent applications, and publications which are incorporated herein by reference conflict with the description of the present application to the extent that it may render a term unclear, the present description shall take precedence.

The present invention will now be illustrated by the following examples, which are not intended to be limiting.

### EXAMPLES

### Materials and Methods

All starting materials used in the examples are commercially available.

### Example 1

### Potentiometry Method to Determine Rp

A Titrando 808 was used in order to determine the weight ratio (Rp) [% weight (SiO₂)/% weight (Na₂O)]. The device was equipped with a reference electrode Ag/AgCl in KCl 3M and a working electrode in tungsten. Each Rp was measured in duplicate and the Rp values presented are the average between the two measurements.

0.5 g of sample was weighed and completed with 30 mL of demineralized water. The titration solution was a 0.1N HCl solution. The volume V1 (mL) was determined as the equivalence of the titration. After the equivalence, 0.5 mL of titration solution was added.

Afterward, 50 mL of KF solution (50 g/l of KF in a water/ethanol (50/50) solution) was added and allowed to react for 3 minutes. Then, 15 mL of 0.1N HCl solution were added. The excess of HCl was titrated by a NaOH 1N solution and the volume V2 (mL) was the equivalent point of the titration.

The Rp was then calculated following the formula below:

$$Rp = ( 0.3 * V 1 ) / ( 1.5 * 1 - V 2 * 1 ) + ( 0.5 * 0.1 ) )$$

### Assay Purity Analysis to Determine the SiO₂ Content

1 g of sample was ignited in a tared platinum dish at 1000° C. for 1 hour, cooled in a desiccator and weighed. The resulting solid was wet with water, 10 mL of hydrofluoric acid were added in small increments. The mixture was then evaporated in a steam bath to dryness and then cooled. 10 mL of hydrofluoric acid and 0.5 mL of sulfuric acid were slowly increased until all of the acids were volatized. The sample was then ignited at 1000° C., cooled in a desiccator and then weighed. The ratio between the difference of the final weight and the weight of the initially ignited portion on the one hand and the weight of the original sample on the other hand represented the weight percentage of SiO₂.

### Carbon Sulfur Analysis (C/S Method) to Determine the Carbon Content

A 200 mg sample was analyzed in Horiba EMIA 320-V2. Lecocel®, iron and tin balls were used as combustion accelerators. CS26-3.19% was used to calibrate the sensor.

### Possible Pre-Treatment of the Precipitated Silica

When the precipitated silica is in a highly agglomerated form such as granules, a pre-treatment thereof is operated before applying the method for determining CTAB surface area, in order to deagglomerate the granules, so as to obtain a precipitated silica sample in the form of a powder.

Precipitated silicas samples in a form of highly agglomerated particles, especially in the form of granules, were smoothly ground using a hand agate mortar and a hand agate pestle, applying manually smooth pressure and friction on the precipitated silica samples so as to cause the destruction of the agglomerates and other lumps contained therein. The grinding was operated for a duration sufficient for the samples to acquire a visually homogeneous consistency that was that of a powder; this duration was generally of a few tens of seconds and did not generally exceed 1 min.

No such pre-treatment is necessary when the precipitated silica is in the form of a powder or in the form of micropearls.

N-hexadecyl-N,N,N-trimethylammonium bromide (CTAB) Method to Determine the Specific Surface Area

CTAB specific surface area (S_{CTAB}) values were determined according to the following method derived from standard NF ISO 5794-1, Appendix G. The method was based on the adsorption of CTAB on the “external” surface of the SiO₂ particles.

In the method, CTAB was allowed to adsorb on precipitated silica under magnetic stirring. Precipitated silica and the residual CTAB solution were then separated. Excess, unadsorbed CTAB was determined by back-titration with bis(2-ehtylhexyl) sulfosuccinate sodium salt (hereinafter “AOT”) using a titroprocessor, the endpoint being given by the turbidity maximum of the solution and determined using an optrode.

### Equipment:

Metrohm Optrode (wavelength: 520 nm) connected to photometer 662 Metrohm; Metrohm Titrator: Titrino DMS 716; Metrohm titration software: Tiamo. Glass beaker (2000 mL); volumetric flasks (2000 ml); sealed glass bottles (1000 and 2000 mL); disposable beakers (100 mL); micropipette (500-5000 μL); magnetic stirring bars with 25 mm discs ends (Ref VWR 442-9431) for adsorption; magnetic stirring bars (straight) for titration; polycarbonate centrifugation tubes (at least 20 mL), centrifuge (allowing a 10000 rpm speed); glass vials (30 mL); thermobalance.

### Preparation of the Solutions:

Preparation of CTAB solution at 5.5 g/L (buffered at about pH 9.6). In a 2000 mL beaker containing about 1000 mL of distilled water at 25° C. were added: 54.25 g of boric acid solution ([c]=4%), 2.60 g of KCl, and 25.8 mL (±0.1 mL) of sodium hydroxide. The so-obtained solution was stirred for 15 minutes before adding 11.0 g±0.01 g of CTAB powder (99.9% purity, purchased from Merck). After stirring, the solution was transferred to a 2000 mL volumetric flask kept at 25° C. and the volume brought at 2000 mL with distilled water. The solution was then transferred in a 2000 mL glass bottle and kept at a temperature not lower than 22° C. to avoid CTAB crystallization (occurring at 20° C.).
Preparation of AOT solution. About 1200 mL of distilled water in a 2000 mL beaker were heated to 35° C. under magnetic stirring. 3.7038 g of AOT (98% purity, purchased from Aldrich) were added. The solution was then transferred to a 2000 mL volumetric flask and allowed to cool back to 25° C. The volume was brought to 2000 mL with distilled water and the solution was transferred in two glass bottles of 1000 mL, which were stored at 25° C. in a dark place.

All equipment and solutions were kept at 25° C. during analysis.

### Procedure at the Beginning and at the End of Each Experiment

Experiment beginning: solutions were agitated before use. The dosing device was purged before use. At least 40 mL of AOT were passed through the device to ensure that the device was clean and that all the air bubbles were removed.

Experiment end: the dosing device was purged in order to remove the AOT solution. The optrode was cleaned and soaked in distilled water.

### Blank Factor Determination

The variation of AOT and CTAB solutions concentrations over time were corrected through the determination of a daily “blank factor” called ratio R1=V1/m¹.

In a 100 mL disposable beaker: 4.9000 g+0.0100 g of the 5.5 g/L CTAB solution (m¹) were accurately weighed. The tare was set and 23.0000 g+1.0000 g of distilled water (MWATER) were accurately added. The solution was placed under stirring using a magnetic stirrer at 500 rpm on the dosing device and the titration was started. Stirring speed must strictly be steady throughout the titration without generating too much air bubbles.

V1 is the end point volume of AOT solution required to titrate the CTAB solution m1.

The R1 determination is performed at least in duplicate. If the standard deviation of R1=V1/m1 exceeds 0.010, the titration is repeated until the standard deviation is lower or equal to 0.010. The daily ratio R1 is calculated as the average of the 2 or 3 measurements.

The optrode must be washed with distilled water after every measurement and dried with absorbent paper.

### CTAB Adsorption on Precipitated Silica

The moisture content (% H₂O) for each precipitated silica sample was determined with a thermobalance (temperature: 160° C.) before the adsorption step as follows: tare the balance with an aluminum cup; weigh about 2 g of precipitated silica and distribute equally the powder on the cup, close the balance; note the percentage of moisture.

In a 100 mL disposable beaker 0.0100 g of precipitated silica (m0) were accurately weighed. 50.0000 mL+1.0000 mL of the CTAB stock solution (V0) were then added. The total mass was recorded. The suspension was stirred for 40 minutes+1 minute on the stirring plate at 450 rpm using magnetic stirring bars with disc ends. After 40 minutes, the sample was removed from the stirring plate.

25 to 50 mL of the suspension were then transferred in a centrifuge tube (volume depends on centrifuge tube size) and they were centrifuged for 35 minutes at a 10000 rpm speed at 25° C. After centrifugation, the tube was gently removed from the centrifuge not to unsettle the precipitated silica. 10 to 20 mL of CTAB solution were transferred in a glass vial, which was then stoppered and kept at 25° C.

### Titration of the CTAB Solution

In a 100 mL disposable beaker: 4.0000 g±0.0100 g of the CTAB solution at unknown concentration (m²) were accurately weighed. Tare was set and 19.4000 g±1.0000 g of distilled water (MWATER) were added. The solution was placed under stirring at 500 rpm on the dosing device and the titration with the AOT solution was started.

V2 is the end point volume of AOT required to titrate an amount m² of CTAB solution.

The CTAB surface area S_{CTAB} is calculated as follows:

$${S}_{CTAB} = \frac{{R}_{1} -}{{R}_{{2}_{{R}_{1}}}} \times [ CTAB ] i \times 578.435 \times \frac{{V}_{0}}{{M}_{ES}}$$

wherein:
S_{CTAB}=surface area of precipitated silica (including the moisture content correction) [m²/g]

$${M}_{ES} = m 0 \times ( 100 - \% H 2 O ) / 100$$

m1=mass of the CTAB stock solution titrated as the blank (kg);
V1=end point volume of AOT required to titrate m1 of the CTAB stock solution as the blank (L)

$$R 2 = V 2 / m 2 ;$$

m2=mass of the CTAB solution titrated after adsorption and centrifugation (kg);
V2=end point volume of AOT required to titrate m² of the CTAB stock solution after adsorption and centrifugation (L)
[CTAB]i=Concentration of the CTAB stock solution (g/L)
V0=Volume of the CTAB stock solution used for the adsorption on precipitated silica (L)
M_{ES}=Solid content of precipitated silica used for the adsorption (g) corrected for the moisture content as follows:

$$R 1 = V 1 / m 1 ;$$

Wherein m0=initial mass of precipitated silica (g)

### Determination of the Specific Surface Area

BET specific surface area SBET was determined according to the Brunauer-Emmett-Teller (BET) method as detailed in standard NF ISO 5794-1, Appendix E (June 2010) with the following adjustments: the sample was pre-dried at 160° C.+10° C.; the partial pressure used for the measurement P/P° was between 0.05 and 0.2.

### Determination of the Particle Size Distribution and Particle Size by Centrifugal Sedimentation in a Disc Centrifuge Using a Centrifugal Photosedimentometer (CPS)

Values of d₅₀, d₁₆, d₈₄, FWHM and Ld were determined by centrifugal sedimentation in a disc centrifuge using a centrifugal photosedimentometer type “CPS DC 24000UHR”, marketed by CPS Instruments company. This instrument is equipped with operating software supplied with the device (operating software version 11g).

Instruments used: for the measurement requirement, the following materials and products were used: Ultrasound system: 1500 W generator type Sonics Vibracell VC1500/VCX1500 equipped with 19 mm probe (Converters: CV154⁺ Boosters (Part No: BHNVC21)+19 mm Probe (Part No: 630-0208)).

Analytical balance with a precision of 0.1 mg (e.g. Mettler AE260); Syringes: 1.0 ml and 2.0 ml with 20 ga needles; high shape glass beaker of 50 mL (SCHOTT DURAN: 38 mm diameter, 78 mm high); magnetic stirrer with a stir bar of 2 cm; vessel for ice bath during sonication.

Chemicals: deionized water; ethanol 96%; sucrose 99%; dodecane, all from Merck; PVC reference standard from CPS Instrument Inc.; the peak maximum of the reference standard used should be between 200 and 600 nm (e.g. 237 nm).

### Preparation of the Disc Centrifuge

For the measurements, the following parameters were established (see Table 1). For the calibration standard parameters, the information of the PVC reference communicated by the supplier were used.

TABLE 1
Sample Parameters

| | | |
|---|---|---|
| max. diameter | μm | 0.79 |
| min. diameter | μm | 0.02 |
| particle density | g/mL | 2.11 |
| particle refractive index | | 1.46 |
| particle absorption | K | 0.001 |
| non-sphericity factor | | 1 |

Calibration Standard Parameters

| | | |
|---|---|---|
| peak diameter | nm | 237 |
| half height peak width | μm | 0.023 |
| particle density | | 1.385 |

Fluid Parameters

| | | |
|---|---|---|
| fluid density | g/mL | 1.051 |
| fluid Refractive Index | | 1.3612 |
| fluid viscosity | cps^{×} | 1.28 |

^{×}cps = centipoise

### System Configuration

The measurement wavelength was set to 405 nm. The following runtime options parameters were established (Table 2):

TABLE 2

| Force Baseline: | Yes |
|---|---|
| Correct for Non-Stokes: | No |
| Extra Software Noise Filtration: | No |
| Baseline Drift Display: | Show |
| Calibration method: | External |
| Samples per calibration: | 1 |

All the others options of the software are left as set by the manufacturer of the instrument.

### Preparation of the Disc Centrifuge

The centrifugal disc is rotated at 24000 rpm during 30 min. The density gradient of sucrose (CAS n°57-50-1) is prepared as follows:

In a 50 mL beaker, a 24% in weight aqueous solution of sucrose is prepared. In a 50 mL beaker, a 8% in weight aqueous solution of sucrose is prepared. Once these two solutions are homogenized separately, samples are taken from each solution using a 2 mL syringe, which is injected into the rotating disc in the following order:
Sample 1:1.8 mL of the 24 wt % solution
Sample 2:1.6 mL of the 24 wt % solution+0.2 mL of the 8 wt % solution
Sample 3:1.4 mL of the 24 wt % solution+0.4 mL of the 8 wt % solution
Sample 4:1.2 mL of the 24 wt % solution+0.6 mL of the 8 wt % solution
Sample 5:1.0 mL of the 24 wt % solution+0.8 mL of the 8 wt % solution
Sample 6:0.8 mL of the 24 wt % solution+1.0 mL of the 8 wt % solution
Sample 7:0.6 mL of the 24 wt % solution+1.2 mL of the 8 wt % solution
Sample 8:0.4 mL of the 24 wt % solution+1.4 mL of the 8 wt % solution
Sample 9:0.2 mL of the 24 wt % solution+1.6 mL of the 8 wt % solution
Sample 10:1.8 mL of the 8 wt % solution.

Before each injection into the disk, the two solutions are homogenized in the syringe by aspiring about 0.2 mL of air followed by brief manual agitation for a few seconds, making sure not to lose any liquid.

These injections, the total volume of which is 18 mL, aim to create a density gradient useful for eliminating certain instabilities which may appear during the injection of the sample to be measured. To protect the density gradient from evaporation, 1 mL of dodecane is added in the rotating disc using a 2 mL syringe. The disc is then left in rotation at 24000 rpm for 60 min before any first measurement.

### Sample Preparation

The sample was prepared and analyzed according to the current protocol, i.e.: PE=3.2 g/40 ml H₂O-suspension subjected to ultrasound at 1500 W for 8 minutes in a refrigerated environment (ice bath)—100 μL sample taken-rotation of the disc at 24000 rpm-analysis time 20-25 minutes. 3.2 g of precipitated silica in a 50 mL high shape glass beaker (SCHOTT DURAN: diameter 38 mm, height 78 mm) were weighed and 40 mL of deionized water were added to obtain a 8 wt.-% suspension of precipitated silica. The suspension was stirred with a magnetic stirrer (minimum 20 s) before placing the beaker into a crystallizing dish filled with ice and cold water. The magnetic stirrer was removed and the crystallizing dish was placed under the ultrasonic probe placed at 1 cm from the bottom of the beaker. The ultrasonic probe was set to 56% of its maximum amplitude and was activated for 8 min. At the end of the sonication, the beaker was placed again on the magnetic stirrer with a 2 cm magnetic stir bar stirring at minimum 500 rpm until after the sampling.

The ultrasonic probe should be in proper working conditions. At least one of the following checks, preferably both, should be carried out: (i) visual check of the physical integrity of the end of the probe (depth of roughness less than 2 mm measured with a fine caliper); (ii) check that the measured d₅₀ of commercial Zeosil® 1165MP precipitated silica is 93 nm±3 nm. In case of negative results, a new probe should be used.

### Analysis

Before each sample was analyzed, a calibration standard was recorded. In each case, 0.1 mL of the PVC standard provided by CPS Instruments and whose characteristics were previously entered into the software was injected. It is important to start the measurement in the software simultaneously with this first injection of the PVC standard. The confirmation of the device has to be received before injecting 100 μL of the previously sonicated sample by making sure that the measurement is started simultaneously at the injection.

These injections were done with 2 clean syringes of 1 mL. At the end of the measurement, which is reached at the end of the time necessary to sediment all the particles of smaller diameter (configured in the software at 0.02 μm), the ratio for each diameter class was obtained. The curve obtained is called aggregate size distribution.

### Results

The values d₅₀, d₁₆, d₈₄ and Ld are based on distributions drawn in a linear scale. The integration of the particle size distribution function of the diameter allows obtaining a “cumulative” distribution, that is to say the total mass of particles between the minimum diameter and the diameter of interest.
d₅₀: is the diameter below and above which 50% by mass of the population of SiO₂ particles is found. The d₅₀ is called median size, which is the median diameter of the precipitated silica.
d₈₄: is the diameter below which 84% of the total mass of particles is measured.
d₁₆: is the diameter below which 16% of the total mass of particles is measured.
Ld: is calculated according to equation: Ld=(d₈₄-d₁₆)/d₅₀

### Determination of Pore Volume and Size of Pores by Mercury (Hg) Porosimetry

Pore volume and pore size distribution were determined using a Micromeritics AutoPore® IV 9520 porosimeter; they were calculated by the Washburn relationship with a contact angle theta equal to 140° and a surface tension gamma equal to 485 dynes/cm. Each sample was dried before the measure in an oven at 200° C. for 2 hours at atmospheric pressure. The starting weight of precipitated silica placed in the type 10 Penetrometer, having an accuracy of 0.001 g, was selected for good reproducibility of the measurement, in such a way that the “stem volume used”, i.e. the percentage mercury (Hg) volume consumed for filling of the penetrometer was from 40% to 80%. The penetrometer was then slowly evacuated to 50 μm of Hg and kept at this pressure for 5 min.

The AutoPore® equipment was operated using Software Version IV 1.09. No corrections were performed on the raw data. The measurement range was from 3.59 kPa (0.52 psi) to 413685 kPa (60000 psi), and at least 100 measurement points were used (19 measurement points from 3.59 kPa (0.52 psi) to 193 kPa (28 psi) with 10 seconds of equilibrium time and then 81 points from 1.93 kPa (0.28 psi) to 413685 kPa (60000 psi) with a 20 seconds equilibrium time). If appropriate, the software introduced further measurement points if the incremental intrusion volume was >0.5 mL/g. The intrusion curve was smoothed by means of the “smooth differentials” function of the equipment software.

The Log Differential Intrusion (mL/g) versus pore size data was analyzed in the pore diameter range from 3.5 nm to 5 μm.

### Example 1—Precipitated Silica Ex-Sand (Comparative)

A reference precipitated silica was produced from a sodium silicate obtained from sand (ex-sand sodium silicate).

The characteristics of the ex-sand sodium silicate (S0) used for this reaction (impurity profile and element composition) are shown in Table 3 below. The Rp value of the sodium silicate was obtained by the potentiometry method described above.

17 L of purified water and 0.260 kg of sodium sulfate ex-sand S0 were introduced in a 25 L stainless steel reactor. The solution thus obtained was heated to 92° C. The entire reaction was carried out at this temperature. 80 g/L sulfuric acid was introduced under stirring (350 rpm, TT mixel stirring) until the pH reaches 4.1.

A sodium silicate solution with a SiO₂/Na₂O weight ratio equal to 3.5 and a concentration of 230 g/L, and sulfuric acid with a concentration equal to 80 g/L were simultaneously introduced into the reactor over a period of 10 minutes, wherein the sodium silicate solution was introduced at a flow rate of 107 g/min and the sulfuric acid was introduced at a flow rate regulated in such a way as to maintain the pH of the reaction medium at a value of 4.1.

At the end of the 10 minutes, the sodium silicate flow rate was kept constant. The 80 g/L sulfuric acid was replaced by the introduction of sulfuric acid at a concentration of 1710 g/L over a period of 16 minutes and at a flow rate that allows to maintain the pH of the reaction medium at a value of 4.1.

The addition of sulfuric acid was then stopped. The sodium silicate was introduced at a flow rate of 107 g/min as long as the pH of the reaction medium was below 8.0.

The pH of the reaction medium was then maintained at 8.0 for 18 minutes by simultaneous addition of sodium silicate at a flow rate of 167 g/min and sulfuric acid with a concentration of 1710 g/L at a regulated flow rate allowing the pH to be maintained.

Finally, at the end of this simultaneous addition, the reaction medium was brought to a pH of 4.0 by adding sulfuric acid at a concentration of 1710 g/L. The medium was matured for 10 minutes at this pH.

The slurry thus obtained was filtered and washed through a filter press (20% dry cake extract). The resulting cake was then mechanically broken down and the resulting slurry was dried using a spray dryer. The characteristics of the precipitated silica thus obtained (precipitated silica P0) are shown in Tables 3 and 4 below.

### Example 2—Precipitated Silica Ex-RHA Washed (Comparative)

A reference precipitated silica was produced from a sodium silicate obtained from rice husk ashes (RHA) which were washed (ex-RHA washed sodium silicate).

### Initial RHA Characteristics:

A rice husk ash (RHA) having the following characteristics, was employed:
SiO₂ concentration was measured by ASSAY purity method as described above: 88.3 wt.-% vs total sample;
Carbon content was analyzed by C/S as described above: 4.9 wt.-% vs total sample.

### RHA Washing:

1000 g of a sulfuric acid solution at a concentration of 0.05 wt.-%, and 50 g of RHA were introduced into a reactor under stirring.

The mixture was kept under stirring and heated to 70° C. for 30 minutes. At the end of the 30 minutes, the RHA and the acidulated water mixture was separated by Büchner filtration in order to concentrate the solid before dissolution.

### RHA Dissolution:

In a 5 L stainless steel 316 L autoclave reactor the following reagents were introduced:
290 g of a soda solution as a concentration of 397 g/L;
1164 g of RHA, and
2560 g of demineralized water.
   The reaction mixture was kept under stirring at 500 rpm with a TT mixel stirrer.

The temperature of the mixture was then raised to 160° C. using the double jacket and maintained for 3 hours.

Once the reaction was complete, a solid/liquid separation was performed by centrifugation. The centrifugate is diluted to reach the targeted SiO₂ concentration and density. The diluted product corresponds to the sodium silicate S1 used for the subsequent silica precipitation step as described below.

The characteristics of the ex-RHA washed sodium silicate (S1) (element composition) are shown in Table 3 below. The Rp of this sodium silicate was analyzed by the potentiometry method described above.

### Silica Precipitation:

17 L of purified water and 0.260 kg of sodium sulfate S1 were introduced in a 25 L stainless steel reactor. The solution was heated to 92° C. The entire reaction was carried out at this temperature.

80 g/L sulfuric acid was introduced under stirring (350 rpm, TT mixel stirring) until the pH reached 4.1.

A sodium silicate solution with a SiO₂/Na₂O weight ratio equal to 3.5 and a concentration of 230 g/L, and sulfuric acid with a concentration equal to 80 g/L were simultaneously introduced into the reactor over a period of 10 minutes, wherein the sodium silicate solution was introduced at a flow rate of 107 g/min and the sulfuric acid was introduced at a flow rate regulated in such a way as to maintain the pH of the reaction medium at a value of 4.1.

At the end of the 10 minutes, the sodium silicate flow rate was kept constant. The 80 g/L sulfuric acid was replaced by the introduction of sulfuric acid at a concentration of 1710 g/L over a period of 16 minutes and at a flow rate that allows to maintain the pH of the reaction medium at a value of 4.1.

The addition of sulfuric acid was then stopped. The sodium silicate was introduced at a flow rate of 107 g/min until the pH of the reaction medium reached 8.0.

The pH of the reaction medium was then maintained at 8.0 for 18 minutes by simultaneous addition of sodium silicate at a flow rate of 167 g/min and sulfuric acid with a concentration of 1710 g/L at a regulated flow rate allowing the pH to be maintained.

Finally, at the end of this simultaneous addition, the reaction medium was brought to a pH of 4.0 by adding sulfuric acid at a concentration of 1710 g/L. The medium was matured for 10 minutes at this pH.

The slurry thus obtained was filtered and washed through a filter press (20% dry cake extract). The resulting cake was then mechanically broken down and the resulting slurry was dried using a spray dryer. The characteristics of the precipitated silica thus obtained (precipitated silica P1) are shown in Tables 3 and 4 below.

### Example 3—Precipitated Silica Ex-RHA Unwashed

A precipitated silica according to the present invention was produced from a sodium silicate obtained from rice husk ashes (RHA) which were not washed (ex-RHA sodium silicate).

### Initial RHA Characteristics:

A rice husk ash (RHA) having the following characteristics, was employed:
SiO₂ concentration was measured by ASSAY purity method as described above: 88.1 wt.-% vs total sample;
Carbon content was analyzed by C/S as described above: 11 wt.-% vs total sample.

### RHA Dissolution:

In a 20 L stainless steel 316 L autoclave reactor, the following reagents were introduced:
1682 g of a soda solution as a concentration of 397 g/L;
3700 g of RHA, and
4628 g of demineralized water.

The reaction mixture was kept under stirring at 800 rpm with a TT mixel stirrer.

The temperature of the mixture was then raised to 160° C. using the double jacket and maintained for 3 hours.

Once the reaction is complete, a solid/liquid separation was performed by centrifugation. The centrifugate is diluted to reach the targeted SiO₂ concentration and density. The diluted product corresponds to the sodium silicate S2 used for the subsequent silica precipitation step as described below.

The characteristics of the unwashed ex-RHA sodium silicate (S2) (element composition) are as shown in Table 3 below. The Rp of this sodium silicate was analyzed by the potentiometry method described above.

### Silica Precipitation:

17 L of purified water and 0.260 kg of sodium sulfate S2 were introduced in a 25 L stainless steel reactor. The solution was heated to 92° C. The entire reaction was carried out at this temperature.

80 g/L sulfuric acid was introduced under stirring (350 rpm, TT mixel stirring) until the pH reached 4.1.

A sodium silicate solution with a SiO₂/Na₂O weight ratio equal to 3.5 and a concentration of 230 g/L, and sulfuric acid with a concentration equal to 80 g/L were simultaneously introduced into the reactor over a period of 10 minutes, wherein the sodium silicate solution was introduced at a flow rate of 107 g/min and the sulfuric acid was introduced at a flow rate regulated in such a way as to maintain the pH of the reaction medium at a value of 4.1.

At the end of the 10 minutes, the sodium silicate flow rate was kept constant. The 80 g/L sulfuric acid was replaced by the introduction of sulfuric acid at a concentration of 1710 g/L over a period of 16 minutes and at a flow rate that allows to maintain the pH of the reaction medium at a value of 4.1.

The addition of sulfuric acid was then stopped. The sodium silicate was introduced at a flow rate of 107 g/min as long as the pH of the reaction medium was below 8.0.

The pH of the reaction medium was then maintained at 8.0 for 18 minutes by simultaneous addition of sodium silicate at a flow rate of 167 g/min and sulfuric acid with a concentration of 1710 g/L at a regulated flow rate allowing the pH to be maintained.

Finally, at the end of this simultaneous addition, the reaction medium was brought to a pH of 4.0 by adding sulfuric acid at a concentration of 1710 g/L. The medium was matured for 10 minutes at this pH.

The slurry thus obtained was filtered and washed through a filter press (20% dry cake extract). The resulting cake was then mechanically broken down and the resulting slurry is dried using a spray dryer. The characteristics of the precipitated silica thus obtained (precipitated silica P2) are shown in Tables 3 and 4 below.

### Example 4

In the following Table (Table 3), the characteristics in terms of impurity profile and element composition of the ex-sand sodium silicate (S0), ex-RHA washed sodium silicate (S1) and unwashed ex-RHA sodium silicate (S2) employed in Examples 1-3, are reported. The characteristics in terms of impurity profile and element composition of the corresponding precipitated silica produced according to Examples 1-3 (P0, P1, and P2), are also reported.

Unless otherwise stated, the amounts in Table 3 are in ppm.

The amounts in the precipitated silica are based on the total weight of the precipitated silica.

In Table 3, the symbol * indicates that the amounts in the silicate solution are based on the total weight of the silicate solution.

The symbol ** indicates that the amounts in the silicate solution are based on the weight of SiO₂

From this Table, it can be seen that the absence of the washing step mainly has an impact on the amount of Mn and P.

TABLE 3

| | Product | Rp (—) | SiO₂ (%) | Mn | P |
|---|---|---|---|---|---|
| RHA | RHA washed | | (100) | 1947 | 409 |
| | RHA | | (100) | 2948 | 1805 |
| | unwashed | | | | |
| Silicate* | Ex-sand (S0) | 3.45 | 20.0 | 5 | 5 |
| | Ex-RHA | 3.45 | 18.8 | 5 | 340 |
| | washed (S1) | | | | |
| | Ex-RHA | 3.48 | 20.0 | 16 | 560 |
| | unwashed (S2) | | | | |
| Silicate** | Ex-sand (S0) | | (100) | 25 | 25 |
| | Ex-RHA | | (100) | 27 | 1809 |
| | washed (S1) | | | | |
| | Ex-RHA | | (100) | 80 | 2800 |
| | unwashed (S2) | | | | |
| Precipitated | Ex-sand (P0) | | (100) | 6 | 6 |
| silica | Ex-RHA | | (100) | 8 | 12 |
| | washed (P1) | | | | |
| | Ex-RHA | | (100) | 21 | 28 |
| | unwashed (P2) | | | | |

In the following Table (Table 4) the characteristics of the precipitated silica produced according to Examples 1-3 described above are reported.

TABLE 4
CTAB, BET, CPS and Hg porosimetry surface
properties of ex-sand, ex-RHA washed and
ex-RHA unwashed precipitated silica samples.

| | | Product | | |
|---|---|---|---|---|
| | | Precipitated | Precipitated | Precipitated |
| | | silica P0 | silica P1 | silica P2 |
| | | Characteristics | | |
| | | Example 1 - | Example 2 - ex- | Example 3 - ex- |
| | | ex-sand | RHA washed | RHA unwashed |
| CTAB (m²/g) | | 197 | 204 | 196 |
| BET (m²/g) | | 222 | 220 | 217 |
| CPS | d₅₀ (nm) | 110 | 111 | 104 |
| | Ld (—) | 1.8 | 1.8 | 1.7 |
| | Mode (nm) | 72 | 70 | 70 |

### Example 5—Rubber Application Performance

Preparation of rubber compositions suitable for the preparation of tire or tire parts: the process for preparing rubber compositions (i.e. precipitated silica-filled elastomeric composition) was conducted in three successive phases.

The first and second mixing stages (non-productive stages, NP1 & NP2) consisted in a thermomechanical working at high temperature, followed by a third mechanical stage (Productive stage, P3) at the temperature below 110° C. The latter allowed the introduction of the vulcanization system.

The first and second stages were carried out by means of an internal mixer from Brabender (net chamber volume 380 mL) with respectively a fill factor of 0.62 and 0.6. The initial temperature and the speed of the raptors were fixed each time so as to reach mixing drop temperatures of about 140-170° C.

Duration of the first mixing stage was between 2 and 10 minutes. After cooling of the mixture (temperature below 100° C.), the second mixing phase allowed the introduction of the vulcanization system (sulfur and accelerator). It was carried out on an open two roll mill, preheated to 50° C.

The duration of this phase was between 2 and 6 minutes.

The final rubber composition was then calendered in sheets of 2-3 mm thickness.

In table 5, the amount of each ingredient of the compositions is expressed as phr (per hundred rubber), that is to say that they are based on the total amount of rubber (here sSBR+BR) that is contained in the rubber formulations.

TABLE 5
Rubber formulation

Rubber composition

| Ingredients | F1 | F2 |
|---|---|---|
| S-SBR | 80 | 80 |
| BR | 20 | 20 |
| Precipitated silica P1 - | 80 | |
| Example 2 | | |
| Precipitated silica P2 - | | 80 |
| Example 3 | | |
| N330 | 3.0 | 3.0 |
| TESPT | 10.0 | 10.0 |
| TDAE | 27.5 | 27.5 |
| Stearic acid | 2.0 | 2.0 |
| Zinc oxide | 2.5 | 2.5 |
| 6-PPD | 1.9 | 1.9 |
| Sulfur | 1.1 | 1.1 |
| CBS | 2.0 | 2.0 |
| DPG | 1.5 | 1.5 |

SSBR with 21% styrene, 49% Vinyl functionalised (Sprintan SLR 4602 from Synthos)
BR: Buna CB 25 from Arlanxeo

TESPT: bis-triethoxysilylpropyl)-tetrasulfide, Si69 from Evonik
N330: Carbon black
TDAE (Treated distillate aromatic extract) Vivatec 500 from Hansen & Rosenthal KG
6-PPD: N-1,3-dimethylbutyl-N-phenyl-para-phenylenediamine (Santoflex 6-PPD from Flexsys)
CBS: N-cyclohexyl-2-benzothiazyl-sulfenamide (Rhenogran CBS-80 from RheinChemie)
DPG: Diphenylguanidine (Rhenogran DPG-80 from RheinChemie)

An evaluation of the rheological properties on the uncured compounds was run to monitor processability indicators. Once the vulcanization characteristics have been determined, uncured compounds were vulcanized at the vulcanization optimum (T98) and mechanical properties and dynamic properties were measured.

### Viscosity of Uncured Compositions

Mooney viscosity was measured at 100° C. using MV200 rheometer according to NF ISO 289 standard. After one minute preheating, the value of the torque was read at 4 minutes (ML1+4-100° C.). The following are determined from the curve of variation in the torque as a function of time:
the minimum torque (Tmin), which reflects the viscosity of the composition at the temperature under consideration;
the maximum torque (Tmax);
the delta torque (ΔT=Tmax−Tmin), which reflects the degree of crosslinking brought about by the action of the crosslinking system and, if the need arises, of the coupling agents;
T.90%, corresponding to the time necessary in order to reach 90% of the maximum torque;
the scorch time TS2, corresponding to the time necessary in order to have a rise of 2 points above the minimum torque at the temperature under consideration and which reflects the time during which it is possible to process the raw mixtures at this temperature without having initiation of vulcanization (the mixture cures from TS2).

The results obtained are shown in Table 6.

### Mechanical Properties of Cured Compositions

Shore A hardness measurement of the cured compositions (Vulcanization time T98 at 160° C.) were performed according to ASTM D 2240 standard. The values were measured after 3 seconds.

The uniaxial tensile tests were performed in accordance with the NF ISO 37 standard with H₂ specimens at a speed of 500 m/min on an INSTRON 5564. Moduli M100 and M300 (respectively obtained at strains 100% and 300%) and tensile strength (TS) are expressed in MPa; elongation at break (EB) is expressed in %. A reinforcement index (RI) defined as the ratio between modulus obtained at 300% strain and the one obtained at 100% strain is calculated.

The properties measured are reported in Table 7.

### Dynamic Properties of Cured Compositions

Dynamic properties were measured on a viscoanalyzer (METRAVIB DMA+1000) according to ASTM D5992.

Dynamic response of cured compounds under strain sweep conditions Parallelepiped specimens (section 8 mm² and height 4 mm) were subjected to a sinusoidal deformation in alternating double shear at a temperature of 40° C. and at a frequency of 10 Hz according to a cycle round trip ranging from 0.1% to 50% for the forward cycle and from 50% to 0.1% for the return cycle. The values of the maximum loss factor (Tan 8 max), the shear storage modulus (G′0.1% and G*12%) and the Payne effect (G′0.1%-G50%) were recorded during the return cycle. The properties measured are reported in Table 8.

### Dynamic Response of Cured Compositions Under Temperature Sweep Conditions

The dynamic response of the vulcanized rubber compositions is measured by soliciting parallelepiped specimens (section 8 mm² and height 7 mm) at a temperature sweep from −70° C. to 100° C. (temperature rise rate +5° C./min), under alternating double shear sinusoidal deformation of 1% and at a frequency of 10 Hz. The maximum loss factor (Tan 8 max) is then measured.

TABLE 6
Uncured

| | | F1 (mean) | F2 (mean) |
|---|---|---|---|
| Delta torque (ΔT) | dN · m | 56.1 | 55.8 |
| TS2 | min | 3.8 | 4.0 |
| T.90% | min | 18.8 | 18.7 |
| Mooney viscosity - | MU | 92 | 90 |
| ML (1 + 4) | | | |

TABLE 7
Mechanical properties/cured

| | | F1 (mean) | F2 (mean) |
|---|---|---|---|
| Hardness ShA - 3 sec | pts | 67 | 68 |
| Modulus 300 | MPa | 17.2 | 15.9 |
| R1 = M300/M100 | — | 4.2 | 4.3 |
| Tensile strength (TS) | MPa | 19.7 | 18.6 |
| Elongation at | % | 332 | 337 |
| break (EB) | | | |
| EB × TS | MPa | 6552 | 6260 |

TABLE 8
Dynamic properties/cured

| | | | F1 (mean) | F2 (mean) |
|---|---|---|---|---|
| Tensile mode | Tan δ max | — | 0.637 | 0.672 |
| (0.089%) | Temperature | ° C. | −21 | −20 |
| | at Tan δ max | | | |
| | Tan δ at 0° C. | — | 0.337 | 0.355 |
| | E′ at 0° C. | Pa | 3.3E+07 | 3.0E+07 |
| | E′ at 40° C. | Pa | 1.4E+07 | 1.2E+07 |
| | Tan δ at 60° C. | — | 0.108 | 0.107 |
| | E* at 60° C. | Pa | 1.1E+07 | 1.0E+07 |
| Shear mode | ΔG′ −40° C. | MPa | 2.7 | 2.7 |
| | Tan δ max −40° C. | — | 0.226 | 0.223 |
| | G* 12% −40° C. | MPa | 1.9 | 1.8 |

The above results demonstrates that rubber compositions comprising the precipitated silica obtained by the process according to the present invention (i.e. ex-RHA unwashed) advantageously shows similar mechanical and dynamic properties to the rubber compositions comprising a precipitated silica obtained by pre-washing the rice husk ashes (i.e. cx-RHA washed).

1. A process for producing a precipitated silica from a plant ash, said process comprising the steps of:
(I) reacting a plant ash containing SiO₂ and manganese in a weight amount, expressed as elemental manganese, of at least 10 ppm, based on the weight of SiO₂ contained in the plant ash, with an alkali metal base, at a temperature of at least 100° C. in an aqueous reaction medium, so as to obtain an aqueous silicate solution comprising (i) SiO₂ in the form of silicate anions and (ii) manganese in a weight amount, expressed as elemental manganese, of at least 10 ppm, based on the weight of SiO₂ contained in the silicate solution,
and
(II) reacting the aqueous silicate solution with an acidifying agent at a temperature of at least 40° C. in an aqueous reaction medium having a pH that exceeds 7.0 during at least part of the duration of the reaction, so as to achieve precipitation of SiO₂ and produce an aqueous slurry comprising SiO₂ in particulate form and manganese in a weight amount, expressed as elemental manganese, of at least 10 ppm, based on the weight of SiO₂ contained in the aqueous slurry,
and said process optionally further comprising a step (A), prior to step (I), of burning a plant and/or a plant part containing SiO₂ and manganese in a weight amount, expressed as elemental manganese, of at least 10 ppm, based on the weight of SiO₂ contained in the plant and/or plant part, so as to obtain the plant ash.

2. The process according to claim 1, said process further comprising step (A) and said process being free of any step (B), after step (A) and before step (I), comprising re-burning the plant ash.

3. The process according to claim 2, said process being further free of any step (B), after step (A) and before step (I), of removing part or all of the manganese and, where present, part or all of phosphorus from the plant ash.

4. The process according to claim 3, wherein the plant ash reacted at step (I) contains manganese in a weight amount, expressed as elemental manganese, of at least 1000 ppm, based on the weight of SiO₂ contained in the plant ash.

5. The process according to claim 4, wherein the plant ash reacted at step (I) contains phosphorus in a weight amount expressed as elemental phosphorus, of at at least 1000 ppm, based on the weight of SiO₂ contained in the plant ash.

6. The process according to claim 5, wherein the aqueous silicate solution contains:
manganese in a weight amount, expressed as elemental manganese, of at least 30 ppm, based on the weight of SiO₂ contained in the aqueous silicate solution, and
phosphorus in a weight amount, expressed as elemental phosphorous, of at least 1000 ppm, based on the weight of SiO₂ contained in the aqueous silicate solution.

7. The process according to claim 1, wherein the plant ash reacted at step (I) contains phosphorus in a weight amount expressed as elemental phosphorus, of at least 1000 ppm, based on the weight of SiO₂ contained in the plant ash.

8. The process according to claim 7, wherein the aqueous silicate solution contains phosphorus in a weight amount, expressed as elemental phosphorous, of at least 1000 ppm, based on the weight of SiO₂ contained in the aqueous silicate solution.

9. The process according to claim 1, wherein the plant ash reacted at step (I) contains carbon in a substantial amount.

10. The process according to claim 9, wherein the plant ash reacted at step (I) contains phosphorus in a weight amount expressed as elemental phosphorus, of at least 1000 ppm, based on the weight of SiO₂ contained in the plant ash.

11. The process according to claim 10, wherein the plant ash reacted at step (I) contains manganese in a weight amount, expressed as elemental manganese, of at least 1000 ppm, based on the weight of SiO₂ contained in the plant ash.

12. The process according to claim 3, said process being further free of any step (B′), before step (A), of removing part or all of the manganese and, where present, part or all of phosphorus from the plant and/or plant part.

13. The process according to claim 3, further comprising the steps of:
(III) filtering the aqueous slurry obtained after step (II) so as to obtain a filter cake comprising SiO₂ in particulate form,
(IV) optionally, washing the filter cake with a liquid containing water,
(V) liquefying the filter cake into a flowable aqueous suspension comprising SiO₂ in particulate form, by adding a liquid containing water to the filter cake and, optionally in addition, by subjecting the filter cake to a mechanical and/or chemical treatment, and
(VI) drying the flowable aqueous suspension so as to obtain the precipitated silica, said process being free of any step (B″), after step (VI), of removing part or all of the manganese and, where present, phosphorus from the precipitated silica.

14. The process according to claim 13, which comprises step (IV) of washing the filter cake with a liquid containing water.

15. The process according to claim 14, said process being further free of any step (B′), before step (A), of removing part or all of the manganese and, where present, part or all of phosphorus from the plant and/or plant part.

16. The process according to claim 15, wherein the plant ash reacted at step (I) contains:
manganese in a weight amount, expressed as elemental manganese, of at least 1000 ppm, based on the weight of SiO₂ contained in the plant ash
phosphorus in a weight amount expressed as elemental phosphorus, of at least 1000 ppm, based on the weight of SiO₂ contained in the plant ash, and
carbon in a substantial amount.

17. The process according to claim 15, wherein the so produced precipitated silica contains SiO₂ in particulate form and manganese in a weight amount, expressed as elemental manganese, ranging from 10 ppm to 75 ppm, based on the weight of SiO₂ contained in the precipitated silica.

18. A precipitated silica containing SiO₂ in particulate form and manganese in a weight amount, expressed as elemental manganese, ranging from 10 ppm to 75 ppm, based on the weight of SiO₂ contained in the precipitated silica.

19. The precipitated silica according to claim 18, which contains manganese in a weight amount, expressed as elemental manganese, ranging from 15 ppm to 30 ppm, based on the weight of SiO₂ contained in the precipitated silica.

20. The precipitated silica according to claim 18, which contains phosphorus in a weight amount, expressed as elemental phosphorus, ranging from 10 ppm to 100 ppm, based on the weight of SiO₂ contained in the precipitated silica.
